(19) United States
(12) Patent Application Publication
(10) Pub. No.: US 2026/0135474 A1
(43) Pub. Date: May 14, 2026

(54) DISPLAY APPARATUS, POWER FACTOR CORRECTION CIRCUIT, AND POWER SUPPLY CONTROL METHOD

(71) Applicants: SILERGY SEMICONDUCTOR TECHNOLOGY (HANGZHOU) CO., LTD., Hangzhou (CN); HISENSE VISUAL TECHNOLOGY CO., LTD., Qingdao (CN)

(72) Inventors: Yongjiang BAI, Hangzhou (CN); Guangxue LIU, Hangzhou (CN)

(21) Appl. No.: 19/442,768

(22) Filed: Jan. 7, 2026

Related U.S. Application Data
(63) Continuation of application No. PCT/CN2024/092734, filed on May 11, 2024.

(30) Foreign Application Priority Data
Aug. 10, 2023 (CN) 202311007912.7

(51) Int. Cl. H02M 1/42; H02M 1/00; H02M 3/335

(52) U.S. Cl. CPC H02M 1/4208; H02M 1/0009; H02M 3/33576

(57) ABSTRACT

Some embodiments of the present application provide a display apparatus, a power factor correction (PFC) circuit, and a power supply control method. The display apparatus comprises the PFC circuit. The PFC circuit may comprise a PFC processor; and a power stage circuit, comprising a first inductor and a power switching transistor; wherein the PFC processor is configured to: output a first enable signal based on a comparison result between an inductor current of the first inductor and a preset current upper limit value; in response to the first enable signal being valid, allow the power switching transistor to be turned on; and in response to the first enable signal being invalid, not allow the power switching transistor to be turned on.

The present application is a continuation of International Application No. PCT/CN2024/092734, filed on May 11, 2024, which claims priority to the Chinese patent application filed with the China National Intellectual Property Administration on Aug. 10, 2023, with application No. 202311007912.7, the entire contents of all of which are incorporated herein by reference.

### TECHNICAL FIELD

The embodiments of the present application relate to display technology, and more specifically, to a display apparatus, a power factor correction circuit, and a power supply control method.

### BACKGROUND

The Power Factor (PF) is a cosine of a phase difference between voltage and current, and can also be expressed as a ratio of effective power to apparent power. The Power factor is a parameter used to measure the power efficiency of electrical equipment. A low power factor represents low power efficiency. By performing Power Factor Correction (PFC) operations, the phase difference between voltage and current can be eliminated or reduced, thereby improving the power factor of the system, improving the transmission efficiency of active power, and improving the power grid environment.

The PFC circuit can include an inductor and a power switching transistor. In some scenarios, such as when the power is turned on or struck by lightning, a surge current will be generated in the PFC circuit. Excessive current will cause damage to components, usually the power switching transistor, in the PFC circuit, which will make the PFC circuit less stable.

### SUMMARY

Some embodiments of the present application provide a display apparatus, which can include: a display panel; a power supply circuit, including a power factor correction (PFC) circuit; where: the power factor correction circuit can include a PFC processor and a power stage circuit; the power stage circuit can include a first inductor and a power switching transistor; and the PFC processor is configured to: output a first signal based on a comparison result between an inductor current of the first inductor and a current upper limit value that is preset; in response to the first signal being valid, allow the power switching transistor to be turned on; and in response to the first signal being invalid, not allow the power switching transistor to be turned on; and a backlight assembly, which is connected to the power supply circuit and can be configured to emit light based on a power supply signal output by the power supply circuit to provide backlight to the display panel.

In some embodiments, in response to the inductor current being lower than the current upper limit value, the valid first signal is output, and in response to the inductor current being not lower than the current upper limit value, the invalid first signal is output.

In some embodiments, the valid first signal can include: a control signal of the power switching transistor, and the invalid first signal can include: a first level signal; and the power switching transistor can be configured to be turned off in response to the first level signal.

In some embodiments, the valid first signal can include: a valid first enable signal, and the invalid first signal can include: an invalid first enable signal; and the power stage circuit further can include a second switching transistor, where the second switching transistor is connected in series with the power switching transistor, and the second switching transistor can be configured to be turned on in response to the valid first enable signal, and be turned off in response to the invalid first enable signal.

In some embodiments, the PFC processor can include: an enable circuit, which can be configured to output a first enable signal of a valid level in response to the inductor current being lower than the current upper limit value, and output a first enable signal of an invalid level in response to the inductor current being not lower than the current upper limit value; and a control signal generating circuit, which is connected to an output terminal of the enable circuit and a control terminal of the power switching transistor, and can be configured to: generate the control signal of the power switching transistor in response to the first enable signal being valid, and output the first level signal in response to the first enable signal being invalid.

In some embodiments, the PFC processor can include: an enable circuit, where an output terminal of the enable circuit is connected to a control terminal of the second switching transistor, and the enable circuit can be configured to output a first enable signal of a valid level in response to the inductor current being lower than the current upper limit value, and output a first enable signal of an invalid level in response to the inductor current being not lower than the current upper limit value.

In some embodiments, the control signal generating circuit can be configured to: in response to the first enable signal being valid, generate the control signal of the power switching transistor based on a turn-on signal adapted to a working mode of the power stage circuit and a turn-off signal adapted to the working mode of the power stage circuit.

In some embodiments, the control signal generating circuit can be configured to: generate a set signal based on at least one of a first indication signal representing an end of a sleep state, a second indication signal representing a completion of a startup configuration, a third indication signal representing a maximum off time, or a turn-on signal adapted to a working mode of the power stage circuit; generate a reset signal based on at least one of a fourth signal representing that the sleep state is entered, a fifth signal representing that the power factor correction circuit enters a protection state, a sixth signal representing a maximum on time, or a turn-off signal adapted to the working mode of the power stage circuit; and in response to the first enable signal being valid, allow to generate the control signal based on the set signal and the reset signal.

In some embodiments, the power factor correction circuit can further include: a current sampling circuit, where a first sampling terminal of the current sampling circuit is connected to a negative input terminal of the power stage circuit and an input terminal of the PFC processor, and a second sampling terminal of the current sampling circuit is connected to one terminal of the power switching transistor and an output terminal of the PFC processor and is grounded; and the current sampling circuit can be configured to sample a current sampling signal representing the inductor current of the first inductor and output the current sampling signal to the PFC processor.

Some embodiments of the present application provide a power factor correction circuit, which can include: a PFC processor; and a power stage circuit, which can includes a first inductor and a power switching transistor; where the PFC processor can be configured to: output a first signal based on a comparison result between an inductor current of the first inductor and a current upper limit value that is preset; in response to the first signal being valid, allow the power switching transistor to be turned on; and in response to the first signal being invalid, not allow the power switching transistor to be turned on.

Some embodiments of the present application provide a power factor correction circuit, which can include: an enable circuit, which can be configured to: receive a current sampling signal representing an inductor current; compare the current sampling signal with a first threshold to generate a first enable signal; in response to the first enable signal being valid, allow a power switching transistor to be turned on; and in response to the first enable signal being invalid, not allow the power switching transistor to be turned on.

In some embodiments, a state of the first enable signal is configured for representing whether the inductor current is lower than a saturation current of an inductor, and in response to the inductor current being lower than the saturation current of the inductor, the first enable signal is valid; in response to the inductor current being equal to the saturation current of the inductor, the first enable signal is invalid.

In some embodiments, the enable circuit generates the valid first enable signal in response to that the enable circuit detects that an absolute value of the current sampling signal is less than an absolute value of the first threshold.

In some embodiments, the power factor correction circuit can further include: a current sampling circuit, where a first terminal of the current sampling circuit is connected to a negative input terminal of a power stage circuit, and a second terminal of the current sampling circuit is connected to one terminal of the power switching transistor and is connected to a ground terminal.

In some embodiments, the current sampling signal is a voltage at the first terminal of the current sampling circuit, and in response to the current sampling signal being greater than the first threshold, the enable circuit is configured to generate the valid first enable signal, where the first threshold is less than zero.

In some embodiments, the power factor correction circuit can further include: a control signal generating circuit, which can includes a set signal generating circuit and a reset signal generating circuit, and configured to: in response to the first enable signal being valid, allow a set signal output by the set signal generating circuit to control the power switching transistor to be turned on; and in response to the first enable signal being invalid, not allow the set signal to control the power switching transistor to be turned on.

In some embodiments, the set signal generating circuit generates the set signal based on at least one of a first indication signal representing an end of a sleep state, a second indication signal representing a completion of a startup configuration, a third indication signal representing a maximum off time, or a turn-on signal adapted to a working mode of a power stage circuit.

In some embodiments, the reset signal generating circuit generates a reset signal based on at least one of a fourth indication signal representing that the power factor correction circuit enters a protection state, a fifth indication signal representing that a sleep state is entered, a sixth indication signal representing a maximum on time, or a turn-off signal adapted to a working mode of the power stage circuit.

Some embodiments of the present application provide a power supply control method, performed by a display apparatus, where the display apparatus can include: a display panel, a power supply circuit and a backlight assembly, where the power supply circuit can include: a power factor correction (PFC) circuit, where the power factor correction circuit can include a PFC processor and a power stage circuit, and the power stage circuit includes a first inductor and a power switching transistor; and the method includes: outputting, by the PFC processor, a first signal based on a comparison result between an inductor current of the first inductor and a current upper limit value that is preset; in response to the first signal being valid, allowing, by the PFC processor, the power switching transistor to be turned on; and in response to the first signal being invalid, not allowing, by the PFC processor, the power switching transistor to be turned on; emitting, by the backlight assembly, light based on a power supply signal output by the power supply circuit to provide backlight to the display panel.

### BRIEF DESCRIPTION OF FIGURES

FIG. 1 is a schematic diagram of an operation scenario between a display apparatus and a control device according to some embodiments of the present application.

FIG. 2 exemplarily shows a configuration block diagram of a control device in some embodiments of the present application.

FIG. 3 is a schematic structural diagram of a display apparatus according to some other embodiments of the present application.

FIG. 4 is a schematic diagram of a connection relationship between a power supply circuit and a load according to some embodiments of the present application.

FIG. 5 is a schematic diagram of a circuit structure of a power supply circuit according to some other embodiments of the present application.

FIG. 6 is a schematic structural diagram of a PFC circuit according to some embodiments of the present application.

FIG. 7 is a first schematic structural diagram of a display apparatus according to some embodiments of the present application.

FIG. 8 is a second schematic structural diagram of a PFC circuit according to some embodiments of the present application.

FIG. 9 is a third schematic structural diagram of a PFC circuit according to some embodiments of the present application.

FIG. 10 is a fourth schematic structural diagram of a PFC circuit according to some embodiments of the present application.

FIG. 11 is a fifth schematic structural diagram of a PFC circuit according to some embodiments of the present application.

FIG. 12 is a first schematic structural diagram of a PFC processor according to some embodiments of the present application.

FIG. 13 is a second schematic structural diagram of a PFC processor according to some embodiments of the present application.

FIG. 14 is a third schematic structural diagram of a PFC processor according to some embodiments of the present application.

FIG. 15 is a fourth schematic structural diagram of a PFC processor according to some embodiments of the present application.

FIG. 16 is a working waveform diagram of a power factor correction circuit in a startup stage according to some embodiments of the present application.

FIG. 17 is a working waveform diagram of the power factor correction circuit in a normal working stage according to the present application.

FIG. 18 is a flowchart of a power supply control method according to some embodiments of the present application.

### DETAILED DESCRIPTION

In order to make the purpose, implementation and advantages of the present application clearer, the exemplary implementation of the present application will be clearly and completely described below in conjunction with the drawings in the exemplary embodiments of the present application. Obviously, the described exemplary embodiments are only part of the embodiments of the present application, rather than all the embodiments.

It should be noted that the brief description of terms in the present application is only for the convenience of understanding the embodiments described below, and is not intended to limit the embodiments of the present application. Unless otherwise specified, these terms should be understood according to their common and usual meanings.

In addition, the terms “include” and “have” and any variations thereof are intended to cover but not exclude inclusion, and for example, a product or device including a list of components is not necessarily limited to those components expressly listed but can include other components not expressly listed or inherent to such products or devices.

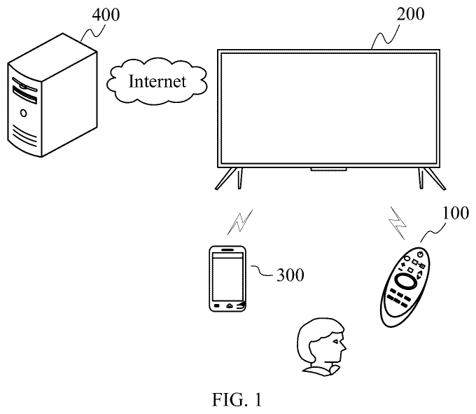

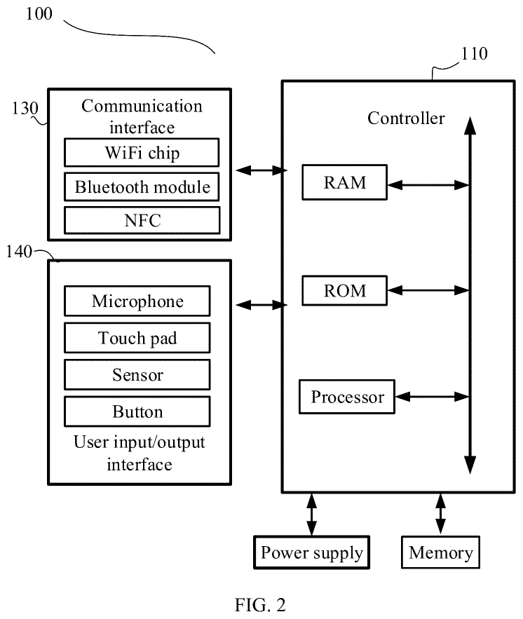

The display apparatus provided in the embodiments of the present application can have various implementation forms, for example, it can be a smart television (TV), a laser projection device, a monitor, an electronic bulletin board, an electronic table, etc. FIG. 1 and FIG. 2 are a specific implementation of the display apparatus of the present application.

FIG. 1 is a schematic diagram of an operation scenario between a display apparatus and a control device according to some embodiments of the present application. As shown in FIG. 1, a user can operate a display apparatus 200 through a smart device 300 or a control device 100.

In some embodiments, the control device 100 can be a remote controller, and the communication between the remote controller and the display apparatus can include infrared protocol communication or Bluetooth protocol communication, and other short-range communication methods, to control the display apparatus 200 wirelessly or wired. The user can input user commands through buttons on the remote controller, voice input, control panel input, etc., to control the display apparatus 200.

In some embodiments, a smart device 300 (such as a mobile terminal, a tablet computer, a computer, a laptop computer, etc.) can also be used to control the display apparatus 200. For example, the display apparatus 200 is controlled using an application running on the smart device.

In some embodiments, the display apparatus cannot use the above-mentioned smart device or control device to receive instructions, but can receive user control through touch or gestures.

In some embodiments, the display apparatus 200 can also be controlled in a manner other than the control device 100 and the smart device 300. For example, the user's voice command control can be directly received through a module for obtaining voice commands configured inside the display apparatus 200, or the user's voice command control can be received through a voice control device set outside the display apparatus 200.

In some embodiments, the display apparatus 200 also communicates data with the server 400. The display apparatus 200 can be allowed to communicate and couple via a local area network (LAN), a wireless local area network (WLAN), and other networks. The server 400 can provide various content and interactions to the display apparatus 200. The server 400 can be one cluster or multiple clusters, and can include one or more types of servers.

FIG. 2 exemplarily shows a configuration block diagram of the control device 100 according to an exemplary embodiment.

In some embodiments, as shown in FIG. 2, the control device 100 can include a controller 110.

In some embodiments, as shown in FIG. 2, the control device 100 can include a communication interface 130.

In some embodiments, as shown in FIG. 2, the control device 100 can include a user input/output interface 140.

In some embodiments, as shown in FIG. 2, the control device 100 can include a memory.

In some embodiments, as shown in FIG. 2, the control device 100 can include a power supply circuit.

In some embodiments, the control device 100 can receive an input operation instruction from a user, and convert the operation instruction into an instruction that can be recognized and responded to by the display apparatus 200, thereby acting as an interactive intermediary between the user and the display apparatus 200.

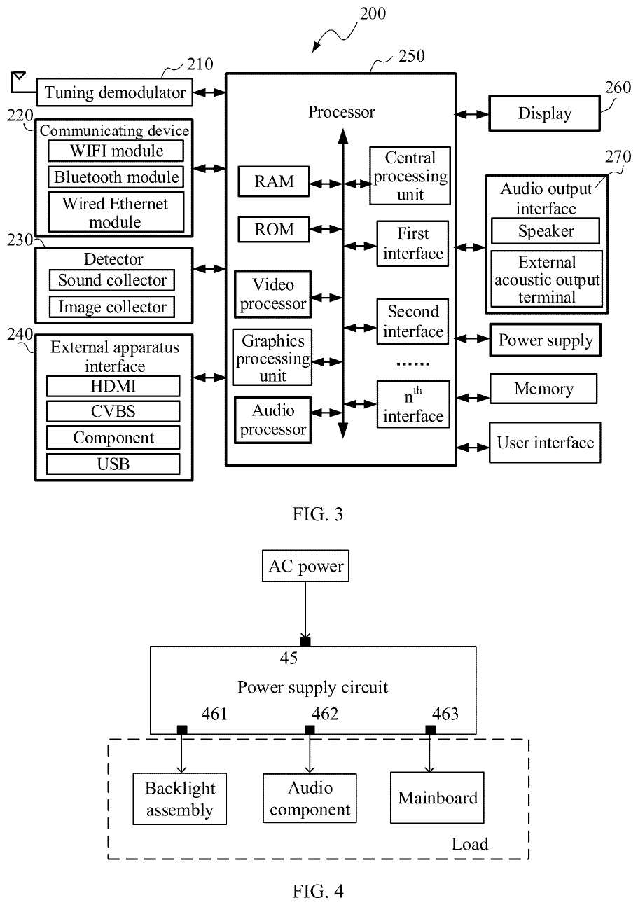

FIG. 3 exemplarily shows a schematic structural diagram of a display apparatus.

In some embodiments, as shown in FIG. 3, the display apparatus 200 can include a tuner-demodulator 210.

In some embodiments, as shown in FIG. 3, the display apparatus 200 can include a communicator 220.

In some embodiments, as shown in FIG. 3, the display apparatus 200 can include a detector 230.

In some embodiments, as shown in FIG. 3, the display apparatus 200 can include an external device interface 240.

In some embodiments, as shown in FIG. 3, the display apparatus 200 can include a controller 250.

In some embodiments, as shown in FIG. 3, the display apparatus 200 can include a display 260.

In some embodiments, as shown in FIG. 3, the display apparatus 200 can include an audio output interface 270.

In some embodiments, as shown in FIG. 3, the display apparatus 200 can include a memory.

In some embodiments, as shown in FIG. 3, the display apparatus 200 can include a power supply circuit.

In some embodiments, as shown in FIG. 3, the display apparatus 200 can include at least one of the user interfaces.

In some embodiments, the controller can include a processor, a video processor, an audio processor, a graphics processor, a random access memory (RAM), a read only memory (ROM), and first to nth interfaces for input/output.

In some embodiments, the display 260 can include a display screen component for presenting images, and a driving component for driving image display, for receiving image signals output from a controller, and for displaying video content, image content, and a menu control interface component and a user interface (UI) operated by the user.

In some embodiments, the display 260 can be a liquid crystal display, an organic light emitting diode (OLED) display, and a projection display.

In some other embodiments, the display 260 can be a projection device and a projection screen.

In some embodiments, the communicator 220 is a component for communicating with an external device or a server according to various communication protocol types.

For example, the communicator can include at least one of a Wifi module, a Bluetooth module, a wired Ethernet module, or other network communication protocol chips or near field communication protocol chips, and an infrared receiver. The display apparatus 200 can establish transmission and reception of control signals and data signals with the external control device 100 or the server 400 through the communicator 220.

In some embodiments, the user interface can be used to receive a control signal from the control device 100 (eg, an infrared remote controller, etc.).

In some embodiments, the detector 230 is used to collect signals of the external environment or external interaction. For example, the detector 230 can include a light receiver, a sensor for collecting the intensity of ambient light; or, the detector 230 can include an image collector, such as a camera, which can be used to collect external environment scenes, user attributes or user interaction gestures; or, the detector 230 can include a sound collector, such as a microphone, etc., for receiving external sounds.

In some embodiments, the external device interface 240 can include, but is not limited to, any one or more of the following interfaces: a high-definition multimedia interface (HDMI), an analog or digital high-definition component input interface (component), a composite video input interface (CVBS), a universal serial bus (USB) input interface, an RGB port, etc. It can also be a composite input/output interface formed by the above multiple interfaces.

In some embodiments, the tuner-demodulator 210 receives broadcast television signals via wired or wireless reception, and demodulates audio and video signals, such as electronic program guide (EPG) data signals, from a plurality of wireless or wired broadcast television signals.

In some embodiments, the controller 250 and the tuner-demodulator 210 can be located in different separate devices, that is, the tuner-demodulator 210 can also be located in an external device of the main device where the controller 250 is located, such as an external set-top box.

In some embodiments, the controller 250 controls the operation of the display apparatus and responds to user operations through various software control programs stored in the memory. The controller 250 controls the overall operation of the display apparatus 200. For example, in response to receiving a user command for selecting a UI object to be displayed on the display 260, the controller 250 can perform operations related to the object selected by the user command.

In some embodiments, the controller can include at least one of a central processing unit (CPU), a video processor, an audio processor, a graphics processing unit (GPU), a RAM, a ROM, a first interface to an nth interface for input/output, a communication bus (Bus), etc.

In some embodiments, the user can input a user command through a graphical user interface (GUI) displayed on the display 260, and the user input interface receives the user input command through the graphical user interface (GUI).

In some other embodiments, the user can input a user command by inputting a specific sound or gesture, and the user input interface recognizes the sound or gesture through a sensor to receive the user input command.

Among them, “user interface” is the medium interface for interaction and information exchange between the application or operating system and the user, which realizes the conversion between the internal form of information and the form acceptable to the user. The commonly used form of user interface is the graphical user interface (GUI), which refers to the user interface related to computer operation displayed in a graphical way. It can be an interface element such as an icon, window, control, etc., displayed on the display screen of an electronic device, where the control can include visual interface elements, such as icons, buttons, menus, tabs, text boxes, dialog boxes, status bars, navigation bars, widgets, etc.

In some embodiments, the display apparatus can include a backlight assembly, where the backlight assembly is connected to a power supply circuit.

In some embodiments, the backlight assembly can be configured to provide backlight to the display panel. In some embodiments, the display apparatus can include: a mainboard 80, which can include at least one of a tuner-demodulator, a communicator, a detector, an external device interface, a controller, an audio output interface, a memory, and a user interface.

FIG. 4 is a schematic diagram of a connection relationship between a power supply circuit and a load according to some embodiments of the present application.

In some embodiments, the power supply circuit can include an input terminal 45 and an output terminal 46 (a first output terminal 461, a second output terminal 462, and a third output terminal 463 are shown in the figure), where the input terminal 45 is connected to the alternating current (AC) power, and the output terminal 46 is connected to the load to output a power supply signal.

In some embodiments, the first output terminal 461 is connected to the backlight assembly, the second output terminal 462 is connected to the speaker, and the third output terminal 463 is connected to the mainboard.

The power supply circuit needs to convert the AC power mains into the direct current (DC) power required by the load, and the DC power usually has different specifications, for example, the audio needs 18V, the panel needs 12V, etc.

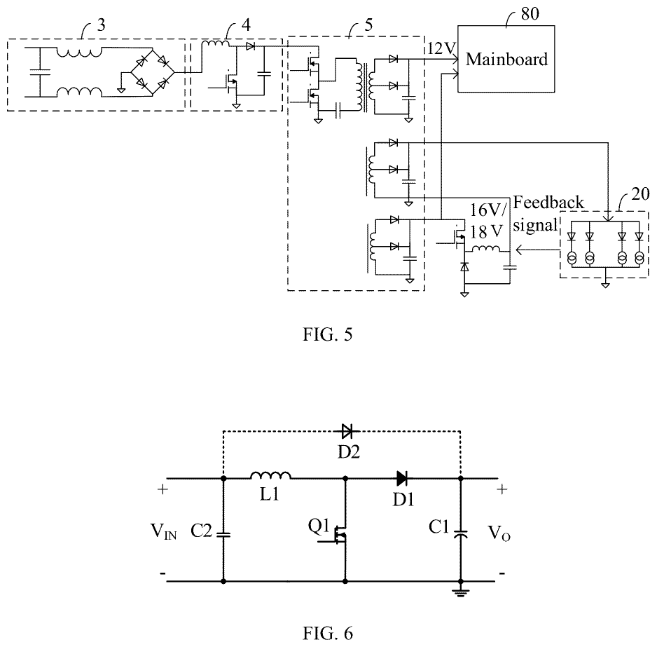

In some embodiments, FIG. 5 is a circuit structure diagram of a power supply circuit according to some embodiments. As shown in FIG. 5, the power supply circuit can also include a filter rectifier circuit 3. The filter rectifier circuit 3 can be configured to obtain AC power, filter the AC power, perform voltage rectification, and output a DC signal.

In some embodiments, the power supply circuit can further include a PFC circuit 4, which is connected to the filter rectifier circuit and can be configured to perform power factor compensation and correction on the DC signal based on the power generated by the present load to improve the utilization rate of the electric energy. The output electric signal is a corrected electric signal.

In some embodiments, the power supply circuit can also include an LLC isolation voltage conversion circuit 5, and the LLC isolation voltage conversion circuit 5 can be configured to convert the corrected electrical signal after power factor correction into a voltage and output the voltage value required for the mainboard 80 and the audio and backlight components 20 to operate normally.

In some embodiments, the PFC circuit 4 can include a first inductor L1.

In some embodiments, the PFC circuit 4 can include a power switch Q1.

In some scenarios, such as when the power is turned on or struck by lightning, a surge current will be generated in the PFC circuit. Excessive current will cause damage to components, usually the power switching transistor, in the PFC circuit, which will make the PFC circuit less stable.

For example, during startup and operation, surge current flows in and causes the inductor saturation. After the inductor is saturated, the internal magnetic field strength B exceeds the maximum saturation flux density Bmax of the core material. At this time, the inductor capacitance decreases rapidly, and the rising slope of the inductor current increases rapidly. The chip cannot turn off the power switching transistor in a very short time (tens of ns). When the power switching transistor is turned on, the current will exceed tens of amperes or hundreds of amperes; and L=N2*Ur*U0*Ae/l. N is the number of inductor turns, Ur is the relative magnetic permeability, U0 is the vacuum magnetic permeability, Ae is the effective cross-sectional area, and l is the magnetic path length. When the inductor is saturated, its Ur will drop rapidly and significantly. Therefore, if there is no diode, the power switching transistor will be damaged by excessive current.

In some embodiments, FIG. 6 is a schematic structural diagram of a PFC circuit 4 in an example. As shown in FIG. 6, a bypass diode D2 is provided between the input terminal and the output terminal of the PFC circuit 4.

When the input surge current has a large rising slope, in order to prevent the surge current from flowing through the inductor L and causing it to be saturated, the current will flow directly from the bypass diode D2 to the first capacitor C1. When this method is adopted, after warming up by the input voltage 264 Vac, when the power on and off are repeatedly switched, the impact current flowing through the bypass diode D2 will exceed the component specifications, which is easy to cause component damage, and cause great inconvenience in its actual application. In addition, it will also lead to cost waste and increase the difficulty of layout design.

To this end, some embodiments of the present application provide a display apparatus, a power factor correction circuit and a power supply control method, where the PFC circuit samples an inductor current of a first inductor and compares the inductor current with an upper current limit value. When the comparison result indicates that a surge current may exist at present, the power switching transistor is controlled not to be turned on by outputting an invalid first signal S1, thereby avoiding damage to the power switching transistor and improving the stability of the PFC circuit.

The following specific embodiments are used to describe the implementation of the present application in detail. The following specific embodiments can be combined with each other, and the same or similar concepts or processes may not be described in detail in some embodiments.

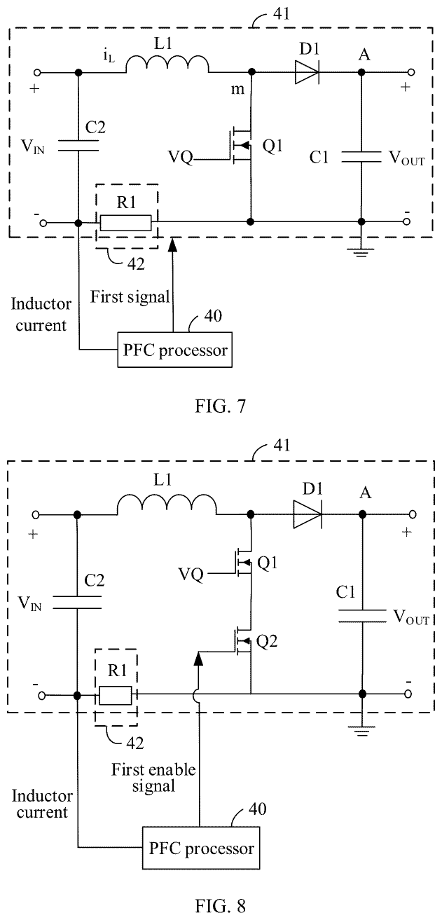

FIG. 7 is a first schematic structural diagram of a display apparatus according to some embodiments of the present application.

In some embodiments, the power supply circuit can include: a PFC circuit 4, where the PFC circuit 4 can include a PFC processor 40 and a power stage circuit 41.

In some embodiments, as shown in FIG. 7, the power stage circuit 41 can include a first inductor L1 and a power switching transistor Q1.

The type of the PFC circuit 4 is not limited in the present application, and it can be a step-up circuit, such as a BOOST circuit; it can also be a step-down circuit, such as a BUCK circuit; or it can also be a boost-buck circuit, or other flyback circuits.

In some embodiments, the power stage circuit 41 can be configured to: drive the power switching transistor Q1 based on the control signal output by the PFC processor 40, and reduce the phase difference between the voltage and the current by driving the power switching transistor Q1 to achieve power factor correction.

The control signal can be a pulse-width modulation (PWM) signal, and the phase difference and the output voltage of the PFC circuit 4 can be controlled by parameters such as the duty cycle and frequency of the PWM signal. The control signal can also be a constant second level signal for controlling the driving power switching transistor Q1 to be turned on.

For the convenience of explanation, the BOOST circuit is taken as an example to exemplify the PFC circuit 4.

In some embodiments, as shown in FIG. 7, the power stage circuit 41 can include: a first inductor L1, one terminal of the first inductor L1 receiving a power input signal V_{IN}, and another terminal of the first inductor L1 connected to one terminal of the power switching transistor Q1.

In some embodiments, as shown in FIG. 7, the power stage circuit 41 can include: a first diode D1, where an anode of the first diode D1 is connected to the another terminal of the first inductor L1.

In some embodiments, as shown in FIG. 7, the power stage circuit 41 can include: a first capacitor C1, where one terminal of the first capacitor C1 is connected to a cathode of the first diode D1 as an output terminal, and another terminal of the first capacitor C1 is grounded.

In the embodiment, the first inductor L1 is used for energy storage, and the first diode D1 is connected between the middle terminal m and the output terminal to rectify the current from the first inductor L1. The second capacitor C2 is connected between the input terminal and the ground terminal to filter the input voltage V_{IN}, and the first capacitor is connected between the output terminal and the ground terminal to filter the output voltage V_{OUT}. The power switching transistor Q1 is controlled by the control signal VQ to switch between on and off, thereby controlling the change of the inductor current and correcting the power factor in an active manner.

In some embodiments, with continued reference to FIG. 7, the PFC processor 40 can be configured to output a first signal S1 based on a comparison result between the inductor current of the first inductor L1 and a preset current upper limit value.

In some embodiments, when the first signal S1 is valid, the power switching transistor Q1 is allowed to be turned on; when the first signal S1 is invalid, the power switching transistor Q1 is not allowed to be turned on.

The upper current limit can be set based on the saturation current of the first inductor L1, and the upper current limit is smaller than the saturation current.

In some embodiments, a “valid” signal can be a signal that enables a component or device that receives the signal to be started or be turned on, and an “invalid” signal can be a signal that enables a component or device that receives the signal to be shut down. Taking a switching transistor as an example, it is turned on when receiving a high level and turned off when receiving a low level, so a high level is a valid signal and a low level is an invalid signal.

In some other embodiments, a “valid” signal can also be understood as a signal that enables a component or device that receives the signal to work normally.

The valid or invalid signals, such as the valid or invalid first enable signal, etc., involved in the following embodiments are also understood with reference to the above explanation. In some embodiments, the state of the first signal S1 is used to indicate whether the inductor current is lower than the saturation current of the inductor. When the inductor current is lower than the saturation current of the inductor, the first signal S1 is valid; and when the inductor current is equal to the saturation current of the inductor, the first signal S1 is invalid.

In some embodiments, as shown in FIG. 7, the power factor correction circuit can further include: a current sampling circuit 42, a first sampling terminal of the current sampling circuit 42 is connected to a negative input terminal of the power stage circuit 41 and an input terminal of the PFC processor 40, and a second sampling terminal of the current sampling circuit 42 is connected to one terminal of the power switching transistor Q1 and an output terminal of the PFC processor 40 and is grounded.

In some embodiments, as shown in FIG. 7, the current sampling circuit 42 can be configured to sample a current sampling signal representing a current of the first inductor L1 and output the current sampling signal to the PFC processor 40.

In the embodiment, the current sampling circuit 42 obtains the voltage at one terminal of the current sampling circuit 42 as the current sampling signal V_{CS}. For example, the current sampling circuit 42 can include a sampling resistor R1, the sampling resistor R1 is connected between the negative input terminal of the power stage circuit 41 and the ground terminal. The current i_{L} flowing through the first inductor L1 forms a voltage drop across the resistor R1 to generate a current sampling signal V_{CS}. Since another terminal of the current sampling circuit 42 is connected to the ground terminal, the current sampling signal here is a negative value.

It should be noted that the current sampling circuit 42 can have other structures as long as it can obtain a value representing the inductor current, and the current sampling signal can also be a positive value, which is not limited in the present application.

There are many ways to control the power switching transistor Q1 to be turned off by the invalid first signal S1, which will be described as an example below.

In some embodiments, as shown in FIG. 7, the PFC processor 40 can be configured to output a valid first signal S1 when the inductor current is lower than the current upper limit value, and output an invalid first signal S1 when the inductor current is not lower than the current upper limit value.

In some embodiments, the valid first signal S1 can include a valid first enable signal, and the invalid first signal can include an invalid first enable signal.

In some embodiments, FIG. 8 is a second schematic structural diagram of a PFC circuit according to some embodiments of the present application. As shown in FIG. 8, the power stage circuit 41 can further include a second switching transistor Q2, where the second switching transistor Q2 is connected in series with the power switching transistor Q1; and the second switching transistor can be configured to be turned on in response to the valid first enable signal, and be turned off in response to the invalid first enable signal.

In the embodiment, the valid first enable signal can be a signal for controlling the second switching transistor to be turned on, and the invalid first enable signal can be a signal for controlling the second switching transistor to be turned off. For example, taking the second switching transistor as a P-channel metal oxide semiconductor (PMOS) transistor as an example, when the control terminal (gate) is at a low level, that is, the voltage between the gate and the source is less than the threshold voltage (Vgs<Vth), the PMOS transistor is turned on, then the low level signal is the valid first enable signal, otherwise the high level is the invalid first enable signal. For another example, taking the second switching transistor as an N-channel metal oxide semiconductor (NMOS) transistor as an example, when the control terminal (gate) is at a high level, that is, the voltage between the gate and the source is greater than the threshold voltage (Vgs>Vth), the NMOS transistor is turned on, then the high level signal is the valid first enable signal, otherwise the low level is the invalid first enable signal.

It is worth noting that the “high level” and “low level” are relative concepts. The “high level” can be a level that can make Vgs>Vth, and the low level can be a level that can make Vgs<Vth.

In some embodiments, as shown in FIG. 8, one terminal of the second switching transistor Q2 is connected to another terminal of the power switching transistor Q1, and another terminal of the second switching transistor Q2 is grounded.

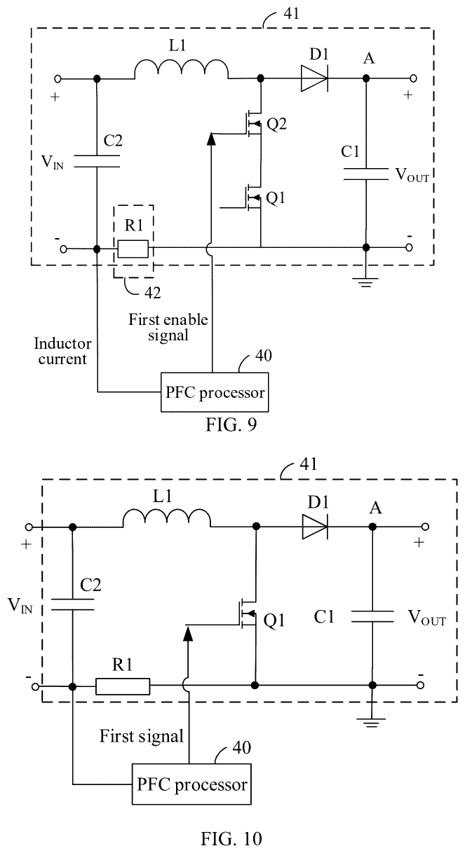

In some embodiments, as shown in a third schematic structural diagram of the PFC circuit in FIG. 9, one terminal of the second switching transistor Q2 is connected to another terminal of the first inductor L1 and a positive electrode of the first diode D1, and another terminal of the second switching transistor Q2 is connected to one terminal of the power switching transistor Q1; and the control terminal of the second switching transistor Q2 is connected to the PFC processor 40 to receive the first enable signal.

In some embodiments, the second switching transistor Q2 is turned on in response to the valid first enable signal, and is turned off in response to the invalid first enable signal.

The second switching transistor Q2 is similar to the power switching transistor Q1 and can include but is not limited to a triode and a field effect transistor.

The above is only an example, and when applied, the second switching transistor Q2 can also be arranged between a power supply input signal terminal and the PFC circuit 4. Alternatively, the second switching transistor Q2 can also be arranged between the power supply input signal terminal and the power supply circuit, so that when the inductor current is too large, the power supply input signal can be directly cut off to protect the PFC circuit 4 or all components in the power supply circuit.

It should be noted that the duration of the surge current is relatively short. In order to reduce the impact on normal operation, based on the above embodiment, the PFC processor 40 can also be configured to output the valid first enable signal after outputting the invalid first enable signal for a first predetermined time. It can be understood that the second switching transistor Q2 is turned on again after the surge voltage passes, and the power supply circuit is controlled to continue to work. Of course, if it is detected that the inductor current is still not lower than the current upper limit value, the invalid first enable signal is output again, and the second switching transistor Q2 is turned off, and this is repeated.

In the above embodiment that can include the second switching transistor Q2, the first signal S1 acts on the second switching transistor Q2 instead of the power switching transistor Q1, so the PFC processor 40 can also output a control signal to the control terminal of the power switching transistor Q1. The control signal and the first signal S1 are two independent signals, so the control signal is not affected by the first signal S1 (first enable signal), which can reduce the modification of the PFC processor 40.

In some other embodiments, FIG. 10 is a fourth schematic structural diagram of the PFC circuit according to some embodiments of the present application. As shown in FIG. 10, the valid first signal S1 can include a control signal of the power switching transistor Q1, and the invalid first signal S1 can include a first level signal or no signal.

In some embodiments, the first level signal is used to control the power switching transistor Q1 to be turned off.

In some embodiments, the control terminal of the power switching transistor Q1 is disconnected when no signal is received. In the embodiment, the first signal S1 acts directly on the power switching transistor Q1. In the working state, when the inductor current is lower than the saturation current, the power switching transistor Q1 is turned on or off in response to the control signal to achieve power factor correction. In the startup state, when the inductor current is lower than the saturation current, the power switching transistor Q1 is turned on in response to the control signal. When the inductor current is equal to the saturation current, the power switching transistor Q1 is turned off in response to the first level signal, so that there is no need to protect the power switching transistor Q1 by adding other external components, thereby simplifying the circuit structure.

It should also be noted that, in combination with the above embodiments, the invalid first signal can include the first level signal, and the valid first signal can include the control signal. The control signal can include a PWM signal for controlling the power switching transistor Q1 to be turned on or off in the working state, and can also include a second level signal for controlling the power switching transistor Q1 to be turned on in the startup state. For example, taking the power switching transistor Q1 as a PMOS transistor as an example, when the control terminal (gate) is at a low level (Vgs<Vth), the PMOS transistor is turned on, then the low level signal is the first level signal, and the high level is the second level signal. For another example, taking the second switching transistor as an NMOS transistor as an example, when the control terminal (gate) is at a high level (Vgs>Vth), the NMOS transistor is turned on, then the high level signal is the second level signal, and the low level is the first level signal.

In some embodiments, FIG. 11 is a fifth schematic structural diagram of the PFC circuit according to some embodiments of the present application. As shown in FIG. 11, the PFC processor 40 can include an enable circuit 43. The enable circuit 43 is connected to the power stage circuit 41 and can be configured to: receive a current sampling signal representing the inductor current, and compare the current sampling signal with a first threshold to generate a first enable signal; allow the power switching transistor Q1 to be turned on when the first enable signal is valid; and not allow the power switching transistor Q1 to be turned on when the first enable signal is invalid.

The current sampling signal can be a sampled voltage signal, and the corresponding inductor current can be obtained based on Ohm's law. The first threshold can be determined based on the current upper limit value and the corresponding relationship between the current sampling signal and the inductor current.

In some embodiments, the enable circuit 43 can be configured to: output a valid first enable signal when the inductor current is lower than the current upper limit value, and output an invalid first enable signal when the inductor current is not lower than the current upper limit value.

The enable circuit 43, when detecting that an absolute value of the current sampling signal V_{CS} is smaller than an absolute value of the first threshold Vₜₕ₁, generates a valid first enable signal V_{EN}.

In some embodiments, the state of the first enable signal V_{EN} is used to represent whether the inductor current of the first inductor L1 is lower than the saturation current of the first inductor L1. When the first enable signal V_{EN} is valid, it represents that the inductor current of the inductor L1 is lower than the saturation current of the first inductor L1, the first inductor L1 has no saturation risk, and the power switching transistor Q1 is allowed to be turned on at this time. When the first enable signal V_{EN} is invalid, it represents that the inductor current of the first inductor L1 is equal to the saturation current of the inductor L, the first inductor L1 has a saturation risk, and the power switching transistor Q1 is not allowed to be turned on at this time.

In some embodiments, as shown in FIG. 11, the enable circuit 43 can include a comparator CMP, where a non-inverting input terminal of the comparator CMP receives the current sampling signal, and an inverting input terminal of the comparator CMP receives the first threshold Vₜₕ₁.

It should be noted that, in some embodiments, since the current sampling signal V_{CS} and the first threshold Vₜₕ₁ are both negative values, and the first threshold Vₜₕ₁ is close to 0, when the current sampling signal is greater than the first threshold Vₜₕ₁, the absolute value of the current sampling signal is less than the absolute value of the first threshold Vₜₕ₁, that is, the current i_{L} flowing through the inductor L is smaller and closer to 0. At this time, a valid first enable signal V_{EN} is generated, allowing the power switching transistor Q1 to be turned on when the normal turn-on signal V1 arrives.

In the embodiment where the valid first signal can include a valid first enable signal, as shown in FIGS. 8 and 9, the output terminal of the enable circuit is connected to the control terminal of the second switching transistor Q2, and the enable circuit can be configured to output the first enable signal to the control terminal of the second switching transistor Q2.

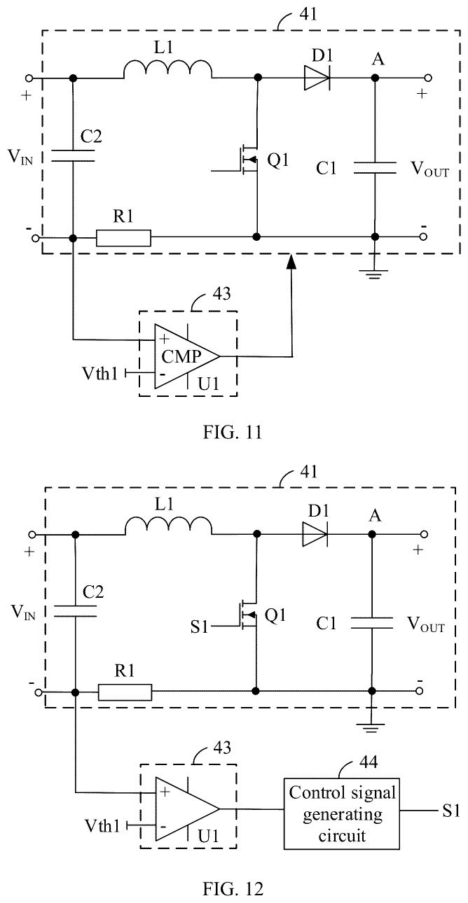

In an embodiment where the valid first signal can include a control signal, FIG. 12 is a schematic structural diagram of a PFC processor according to some embodiments of the present application. As shown in FIG. 12, the PFC processor 40 can further include: a control signal generating circuit 44 connected to the output terminal of the enable circuit 43 and the control terminal of the power switching transistor Q1.

In some embodiments, the control signal generating circuit 44 can be configured to: generate the control signal for the power switching transistor Q1 when the first enable signal is valid; and output the first level signal when the first enable signal is invalid.

In some embodiments, the control signal generating circuit 44 can be configured to generate the control signal based on the PWM signal when the first enable signal is valid.

In some embodiments, the PFC processor 40 can further include a PWM signal generating unit, and the PWM signal generating unit is connected to the control signal generating circuit 44 and can be configured to generate the PWM signal.

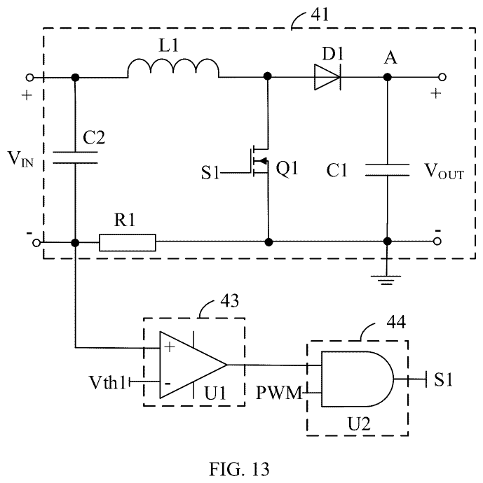

In some embodiments, FIG. 13 is a second schematic structural diagram of a PFC processor according to some embodiments of the present application. As shown in FIG. 13, the control signal generating circuit 44 can include: a first AND gate U2, where a first input terminal of the first AND gate U2 receives a first enable signal, and a second input terminal of the first AND gate U2 receives a PWM signal; and an output terminal of the first AND gate U2 is connected to a control terminal of the power switching transistor Q1.

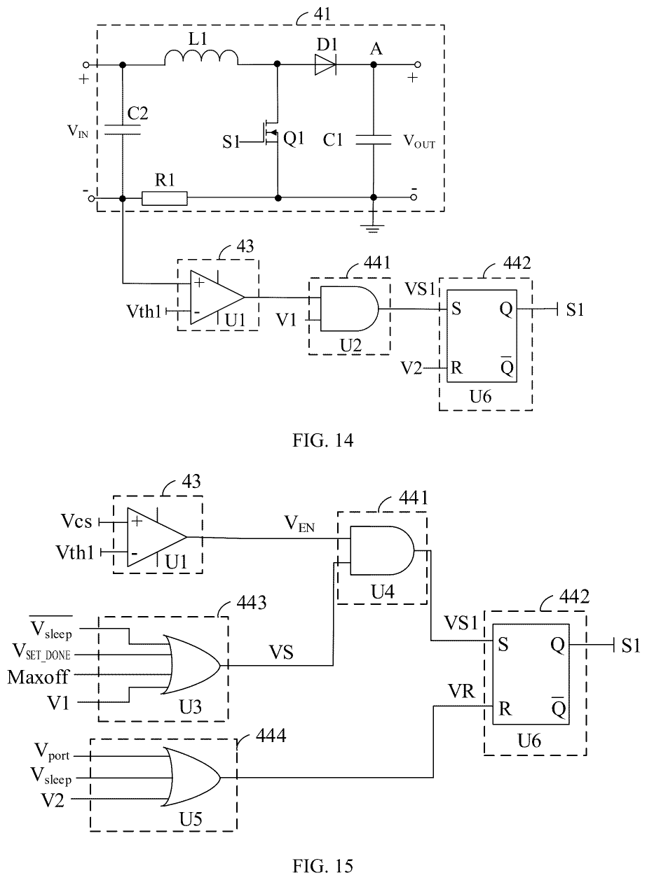

In some embodiments, FIG. 14 is a third schematic structural diagram of a PFC processor according to some embodiments of the present application. As shown in FIG. 14, the control signal generating circuit 44 can be configured to, when the first enable signal is valid, generate a control signal of the power switching transistor Q1 based on a turn-on signal V1 adapted to the working mode of the power stage circuit 41 and a turn-off signal V2 adapted to the working mode of the power stage circuit 41.

In some embodiments, the turn-on signal V1 adapted to the working mode of the power stage circuit 41 means that if the power stage circuit 41 works in a fixed frequency mode, the turn-on signal V1 can be a fixed frequency clock signal; and if the power stage circuit 41 works in a fixed off time mode, the turn-on signal V1 can be a fixed off time signal.

In some embodiments, the turn-off signal V2 adapted to the working mode of the power stage circuit 41 means that if the power stage circuit 41 works in a fixed on time mode, the turn-off signal V2 can be a fixed on time signal; and if the power stage circuit 41 works in a peak current mode, the turn-off signal V2 can be a comparison signal representing that the inductor current reaches the peak current threshold.

For example, if the power stage circuit 41 is turned on at a high level and turned off at a low level, the turn-on signal is at a high level and can include a rising edge, and the turn-off signal is at a low level and can include a falling edge.

In some embodiments, the turn-off signal V2 and the turn-on signal V1 are a pair of complementary signals. When the turn-on signal V1 is at a high level, the turn-off signal V2 is at a low level; and when the turn-on signal V1 is at a low level, the turn-off signal V2 is at a high level.

It can be understood that, for example, the control signal generating circuit in FIG. 13 generates the control signal using the PWM signal generated by the PWM signal generating unit, and for example, in FIG. 14 the control signal is generated using the turn-on signal and the turn-off signal. In other words, the control signal generating circuit in FIG. 14 partially acts as the PWM signal generating unit.

In some embodiments, as shown in FIG. 14, the control signal generating circuit can include a first AND gate U2. The first AND gate U2 generates an output signal VS1.

In some embodiments, as shown in FIG. 14, the control signal generating circuit can include a flip-flop U6.

In some embodiments, FIG. 15 is a fourth schematic structural diagram of a PFC processor according to some embodiments of the present application. As shown in FIG. 15, the control signal generating circuit can be configured to: generate a set signal VS based on at least one of a first indication signal representing an end of a sleep state, a second indication signal representing a completion of a startup configuration, a third indication signal representing a maximum off time, or a turn-on signal adapted to a working mode of the power stage circuit.

In some embodiments, as shown in FIG. 15, the control signal generating circuit can be configured to generate a reset signal VR based on at least one of a fourth signal representing entry into a sleep state, a fifth signal representing that the power factor correction circuit enters a protection state, a sixth signal representing a maximum on time, or a turn-off signal adapted to the working mode of the power stage circuit.

In some embodiments, as shown in FIG. 15, the control signal generating circuit can be configured to allow the control signal to be generated based on the set signal and the reset signal when the first enable signal is valid.

In some embodiments, when the first indication signal V̅s̅l̅e̅e̅p̅ is at a valid level, it indicates that the display apparatus is not in the sleep state, and when the first indication signal is at an invalid level, it indicates that the display apparatus is in the sleep state. When the second indication signal V_{SET_DONE} is at a valid level, it indicates that the display apparatus is in a state of completing the power-on configuration, and when the second indication signal V_{SET_DONE} is at an invalid level, it indicates that the display apparatus is in a state of not completing the power-on configuration. When the third indication signal Maxtoff is at a valid level, it indicates that the present maximum off time is ended, and when the third indication signal Maxtoff is at an invalid level, it indicates that the present maximum off time is not ended. The fourth indication signal Vsleep is complementary to the first indication signal V̅s̅l̅e̅e̅p̅ that indicates the end of the sleep state. When the fifth indication signal Vprot is at a valid level, it indicates that the display apparatus enters a protection state, and when the fifth indication signal Vprot is at an invalid level, it indicates that the display apparatus does not enter a protection state.

In the above-mentioned embodiments of FIG. 13 and FIG. 14, only the method of generating the control signal when the PFC circuit is working normally is considered, while in this embodiment, the method of generating the control signal in the stages of starting, maximum off time, sleep and protection is also considered. That is, when the first enable signal is valid, the control signal can be generated based on at least one valid signal among the starting, maximum off time, sleep and turn-on signals. In these stages, if the inductor current is greater than the current upper limit value, the control signal still cannot be output, so in this embodiment the protection of the power switching transistor in each stage is realized, thereby further improving the stability of the PFC circuit.

It should be noted that the first signal S1 that is output based on the first indication signal V̅s̅l̅e̅e̅p̅, the second indication signal V_{SET_DONE}, the third indication signal, the fourth indication signal, the fifth indication signal, and the sixth indication signal is only an example. The first signal S1 can also be generated based on any one or more of the six signals. Alternatively, not limited to the above six signals, the first signal S1 can also be generated based on other indication signals in scenarios where the power switching transistor Q1 is not required to be turned on or off.

In some embodiments, the control signal generating circuit can include: a set signal generating circuit.

In some embodiments, the control signal generating circuit can include: a reset signal generating circuit.

In some embodiments, the control signal generating circuit can be configured to allow the set signal output by the set signal generating circuit to control the power switching transistor Q1 to be turned on when the enable signal is valid; and not allow the set signal to control the power switching transistor Q1 to be turned on when the enable signal is invalid.

In some embodiments, the control signal generating circuit 44 is used to generate a control signal VQ for turning on the power switch Q1 at least according to the enable signal V_{EN}, the set signal VS, and the reset signal VR.

In some embodiments, the set signal generating circuit generates a set signal based on at least one of a first indication signal.

indicating the end of the sleep state, a second indication signal V_{SET_DONE} indicating the completion of the startup configuration, a third indication signal indicating the maximum off time, and a turn-on signal V1 adapted to the working mode of the power stage circuit 41.

In some embodiments, the reset signal generating circuit generates a reset signal based on at least one of a fourth indication signal indicating entry into a sleep state, a fourth indication signal indicating entry into a protection state, a fifth indication signal indicating entry into a sleep state, a sixth indication signal indicating a maximum on time, or a turn-off signal V2 corresponding to the working mode of the power stage circuit 41.

In some embodiments, FIG. 15 is a fifth schematic structural diagram of a PFC processor according to some embodiments of the present application. As shown in FIG. 15, the control signal generating circuit 44 can further include: a first logic circuit 441.

In some embodiments, as shown in FIG. 15, the control signal generating circuit 44 can further include: a second logic circuit 442.

In some embodiments, as shown in FIG. 15, the first logic circuit 441 is connected to the output terminal of the set signal generating circuit and receives the first enable signal VS1.

In some embodiments, the first logic circuit 441 can be configured to output a valid first set signal when the first enable signal is valid and the set signal generating circuit outputs a valid set signal.

In some embodiments, the first input terminal of the second logic circuit 442 is connected to the output terminal of the first logic circuit 441, the second output terminal of the second logic circuit 442 is connected to the output terminal of the reset signal generating circuit, and the output terminal of the second logic circuit 442 is connected to the power switching transistor Q1. The second logic circuit can be configured to generate a control signal when the first set signal is valid and the reset signal is invalid.

In some embodiments, the set signal generating circuit can include a first OR gate U3.

In some embodiments, the reset signal generating circuit can include a second OR gate U5.

In some embodiments, the first logic circuit 441 can include a first AND gate U2.

In some embodiments, the second logic circuit 442 can include a flip-flop U6.

The present application does not limit the type of flip-flop. For example, it can be an R-S flip-flop, a J-K flip-flop, or a T flip-flop. Taking the R-S flip-flop as an example, the R-S flip-flop is formed by cross-coupling two NAND gates or two NOR gates.

As shown in FIG. 15, the pin S is connected to the output terminal of the second AND gate U4, and the pin R is connected to the output terminal of the second OR gate U5; the pin Q is the output terminal connected to the control terminal of the power switching transistor Q1. The constraint equation of the pin S and the pin R is S+R=1. When the pin S is 1 and the pin R is 0, the output is 1. When the pin S is 0 and the pin R is 1, the output is 0. When both S and R are 1, the output Q remains unchanged and is latched. When both S and R are 0, it is an invalid state. In other words, the flip-flop has the memory function and the function of presenting invalid data. The memory function of the flip-flop can eliminate the interference caused by the switch vibration, thereby further improving the stability of the PFC circuit.

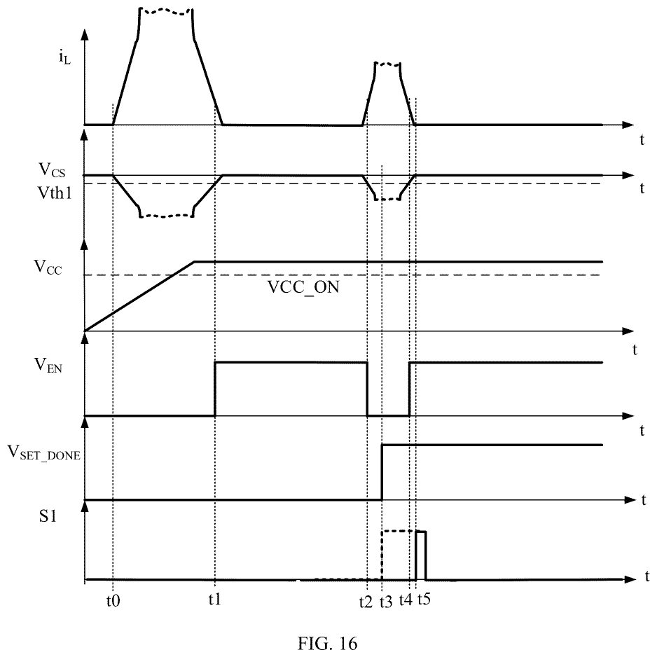

FIG. 16 is a working waveform diagram of a power factor correction circuit at a startup stage in some embodiments of the present application. The specific working process is described below in conjunction with FIG. 15 and FIG. 16.

At time t0, the surge current comes, but at this time the system has not yet been powered on to the power supply voltage V_{CC}, and the startup configuration has not yet been completed. The second indication signal V_{SET_DONE}, which indicates that the startup configuration is completed, is in an invalid state, so there will not be any signal representing the setting to make the set signal VS valid. Therefore, the power switching transistor Q1 will not be turned on before the system is powered on to the power supply voltage V_{CC} and the startup configuration is completed. Therefore, there is no risk of excessive surge current causing inductor saturation and then causing the power switching transistor Q1 to be damaged. At this time, the surge current will flow through the first inductor L1, the first diode D1, and the first capacitor C1.

At time t1, the current sampling signal V_{CS} rises to be greater than the first threshold Vₜₕ₁ (here V_{CS} and Vₜₕ₁ are both negative values), which indicates that the absolute value of the current sampling signal V_{CS} is less than the absolute value of the first threshold Vₜₕ₁, that is, the current i_{L} flowing through the first inductor L1 is smaller and closer to zero. At this time, the enable circuit 43 generates a valid first enable signal V_{EN}, and the control signal generating circuit 44 allows the set signal VS output by the set signal generating circuit 443 to control the power switching transistor Q1 to be turned on.

At time t2, the current sampling signal V_{CS} drops to be less than the first threshold Vₜₕ₁ (here V_{CS} and Vₜₕ₁ are both negative values), which indicates that the absolute value of the current sampling signal V_{CS} is greater than the absolute value of the first threshold Vₜₕ₁, that is, it indicates that the current i_{L} flowing through the first inductor L1 is large. At this time, the enable circuit 43 generates an invalid enable signal V_{EN}, and the control signal generating circuit 44 prohibits the set signal VS output by the set signal generating circuit 443 to control the power switching transistor Q1 to be turned on.

At time t3, the surge current still exists. At this time, the system initialization is completed, and the second indication signal V_{SET_DONE} representing the startup configuration state jumps to a valid level. Please refer to FIG. 15. At this time, the set signal generating circuit 443 outputs a valid set signal VS when the second indication signal V_{SET_DONE} is at a valid level, as shown by the dotted line in the waveform of the first signal S1 in FIG. 16. At this time, the control signal generating circuit 44 is ready to send a valid first signal S1 to turn on the power switching transistor Q1. Since the current i_{L} of the first inductor L1 is large at this time, the first inductor L1 tends to saturation. If the power switching transistor Q1 is turned on, the power switching transistor Q1 and the drive control circuit will be damaged. However, in the embodiment of the present application, the enable circuit 43 is provided. At this time, the enable signal V_{EN} is at an invalid state. The control signal generating circuit 44 prohibits the set signal VS output by the set signal generating circuit 443 from controlling the power switching transistor Q1 to be turned on. Therefore, at time t3, the power switching transistor Q1 is temporarily not turned on.

At time t4, the current sampling signal V_{CS} rises to be greater than the first threshold Vₜₕ₁. At this time, the enable circuit 43 generates a valid enable signal V_{EN}, and the control signal generating circuit 44 allows the set signal generating circuit 443 to output the set signal VS to control the power switching transistor Q1 to be turned on. At the subsequent time t5, when the turn-on signal V1 corresponding to the working mode jumps to be valid, the valid state of the set signal VS comes, and the power switching transistor Q1 is turned on. At this time, since the current i_{L} of the inductor L is small, the turned-on of the power switching transistor Q1 will not bring the risk of damaging the circuit.

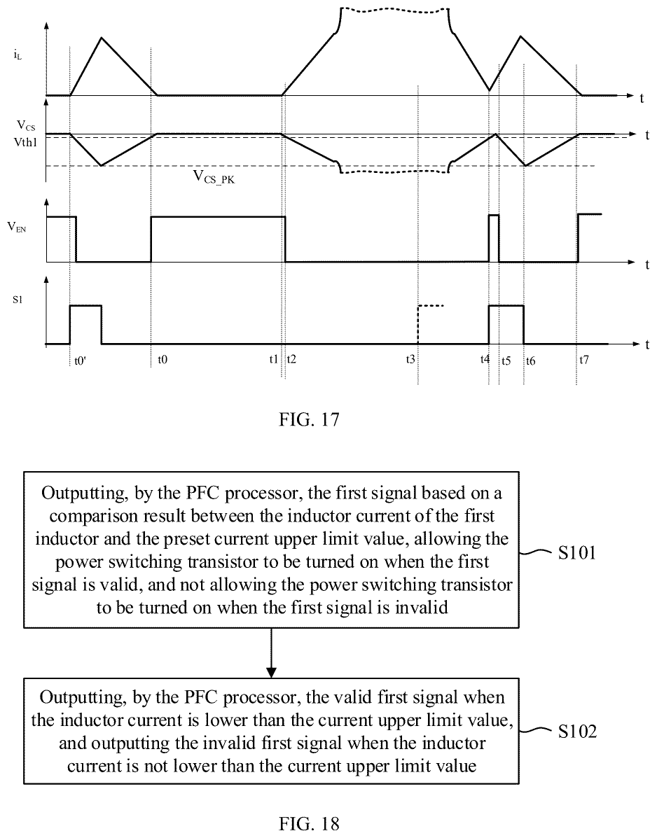

FIG. 17 is a working waveform diagram of the power factor correction circuit of the present application in the normal working stage. The specific working process is described below in conjunction with FIG. 15 and FIG. 17.

At time t0, the enable signal V_{EN} is valid, and the control signal generating circuit 44 allows the set signal VS output by the set signal generating circuit 443 to control the power switching transistor Q1 to be turned on.

At time t1, the surge current comes, but the current sampling signal V_{CS} has not dropped below the first threshold Vₜₕ₁.

At time t2, the current sampling signal V_{CS} drops to less than the first threshold Vₜₕ₁, at which time the enable circuit 43 generates an invalid enable signal V_{EN}, and the control signal generating circuit 44 prohibits the set signal VS output by the set signal generating circuit 443 to control the power switching transistor Q1 to be turned on.

At time t3, according to the control logic of the set signal generating circuit 443, for example, in the QR control mode, the power switching transistor Q1 needs to be turned on, or in the CCM control mode when Toff reaches the maximum off time Maxtoff, the power switching transistor Q1 needs to be turned on when the timing of switching cycle Ts is reached, the set signal VS is at a valid level at this time, and the power switching transistor Q1 needs to be turned on. However, at this time, turning on the power switching transistor Q1 has the risk of damaging the power switching transistor Q1 and the drive control circuit, etc., and the invalid enable signal V_{EN} makes the first set signal VS1 at an invalid level, so the power switching transistor Q1 is temporarily not turned on.

At time t4, the current sampling signal V_{CS} rises to reach the first threshold Vₜₕ₁, and the enable circuit 43 generates a valid enable signal V_{EN} which is at a high level. At this time, it is considered that the surge current is over, and the power switching transistor Q1 is allowed to be turned on. If the turn-on signal V1 corresponding to the working mode jumps to be valid at this time, the set signal VS is at a valid level which is a high level, the first signal S1 is at a high level, the inductor current i_{L} rises, and the power switching transistor Q1 can be controlled to be turned on. At this time, the turned-on does not have the risk of damaging the circuit.

At time t5, the current sampling signal V_{CS} is lower than the first threshold Vₜₕ₁, the enable circuit 43 generates an invalid enable signal V_{EN} which is at a low level, and the power switching transistor Q1 is not allowed to be turned off.

At time t6, the first signal S1 is at a low level.

At time t7, the current sampling signal V_{CS} rises to reach the first threshold Vₜₕ₁ again, and the enable circuit 43 generates the valid enable signal V_{EN} which is at the high level.

In the display apparatus provided in the embodiment of the present application, the PFC processor of the PFC circuit detects the inductor current of the first inductor and compares the inductor current with the first threshold. When the comparison result indicates that the surge current may exist at present, the PFC processor outputs the invalid first signal to control the power switching transistor to not be turned on, thereby avoiding damage to the power switching transistor and improving the stability of the PFC circuit.

In some embodiments, the present application further provides a power factor correction circuit, which can include: a PFC processor and a power stage circuit; where the power stage circuit can include a first inductor and a power switching transistor.

In some embodiments, the PFC processor can be configured to output a first signal based on a comparison result between an inductor current of the first inductor and a current upper limit value that is preset; in response to the first signal being valid, allow the power switching transistor to be turned on; and in response to the first signal being invalid, not allow the power switching transistor to be turned on.

The specific structures and configurations of the PFC processor and the power switching transistor can refer to the above embodiments and will not be described in detail here.

In some embodiments, the enable circuit and/or the control signal generating circuit are integrated inside the PFC processor. As described in the above embodiments, the PFC processor is a control chip, and the enable circuit and/or the control signal generating circuit are integrated inside the PFC processor, which can simplify the structure of the PFC circuit and reduce the volume.

In some other embodiments, the enable circuit and/or the control signal generating circuit exist independently of the PFC processor.

In the PFC circuit provided in some embodiments, the PFC circuit can include: the enable circuit, which can be configured to receive a current sampling signal representing the inductor current, and compare the current sampling signal with a first threshold to generate a first enable signal; when the first enable signal is valid, the power switching transistor is allowed to be turned on; and when the first enable signal is invalid, the power switching transistor is not allowed to be turned on.

In some embodiments, the power factor correction circuit can further include: a control signal generating circuit, which can include a set signal generating circuit and a reset signal generating circuit, and configured to: in response to the enable signal being valid, allow a set signal output by the set signal generating circuit to control the power switching transistor to be turned on; and in response to the enable signal being invalid, not allow the set signal to control the power switching transistor to be turned on.

Disposing the enable circuit and/or the control signal generating circuit at the periphery of the PFC processor can reduce interference to the PFC processor and reduce manufacturing difficulty.

In the embodiment where the enable circuit and/or the control signal generating circuit are independently provided from the PFC processor, the specific structures and configurations of the enable circuit and the control signal generating circuit can refer to the above embodiments and will not be described in detail here.

FIG. 18 is a flow chart of a power supply control method according to some embodiments of the present application. The power supply control method is performed by the display apparatus in any of the above embodiments, as shown in FIG. 18, and can include the following steps.

S101, the PFC processor outputs the first signal based on a comparison result between the inductor current of the first inductor and the preset current upper limit value, allows the power switching transistor to be turned on when the first signal is valid, and does not allow the power switching transistor to be turned on when the first signal is invalid.

In some embodiments, S102 can include the following. The PFC processor outputs the valid first signal when the inductor current is lower than the current upper limit value, and outputs the invalid first signal when the inductor current is not lower than the current upper limit value.

The valid first signal can include: a control signal of the power switching transistor, and the invalid first signal can include: a first level signal, and the first level signal is used to control the power switching transistor to be turned off.

In some other embodiments, S102 can include the following.

The enable circuit outputs a first enable signal of a valid level when the inductor current is lower than a first threshold, and outputs a first enable signal of an invalid level when the inductor current is not lower than the first threshold.

The control signal generating circuit generates a control signal for the power switching transistor when the first enable signal is valid, and outputs the first level signal when the first enable signal is invalid.

In some embodiments, the control signal generating circuit, in response to the first enable signal being valid, generates the control signal of the power switching transistor based on a turn-on signal adapted to a working mode of the power stage circuit and a turn-off signal adapted to the working mode of the power stage circuit.

In some embodiments, the control signal generating circuit generates a set signal based on at least one of a first indication signal representing an end of a sleep state, a second indication signal representing a completion of a startup configuration, a third indication signal representing a maximum off time, or a turn-on signal adapted to a working mode of the power stage circuit.

In some embodiments, the control signal generating circuit generates a reset signal based on at least one of a fourth signal representing that a sleep state is entered, a fifth signal representing that the power factor correction circuit enters a protection state, a sixth signal representing a maximum on time, or a turn-off signal adapted to the working mode of the power stage circuit.

In some embodiments, the control signal generating circuit, in response to the first enable signal being valid, allows to generate the control signal based on the set signal and the reset signal.

The specific structures of the PFC processor and the enable circuit and the control signal generating circuit in the PFC processor can refer to the above implementations, which will not be described in detail here.

In the power supply control method provided in the embodiment of the present application, the PFC processor of the PFC circuit measures the inductor current of the first inductor and compares the inductor current with the first threshold. When the comparison result indicates that the surge current can exist at present, the invalid first signal is outputted by the PFC processor to control the power switching transistor to be not turned on, thereby avoiding damage to the power switching transistor and improving the stability of the PFC circuit.

Finally, it should be noted that the above embodiments are only used to illustrate the implementation methods of the present application, rather than to limit them. Although the present application has been described in detail with reference to the aforementioned embodiments, a person of ordinary skill in the art should understand that the implementation methods described in the aforementioned embodiments may still be modified, or some or all of the technical features therein may be replaced by equivalents. However, these modifications or replacements do not cause the essence of the corresponding implementation methods to deviate from the scope of the implementation methods of the embodiments of the present application.

For the convenience of explanation, the above description has been made in conjunction with specific embodiments. However, the above exemplary discussion is not intended to be exhaustive or limit the embodiments to the specific forms disclosed above. Based on the above teachings, various modifications and variations can be obtained. The selection and description of the above embodiments are to better explain the principles and practical applications, so that those skilled in the art can better use the embodiments and various different variations of the embodiments suitable for specific use considerations.

What is claimed is:

1. A power factor correction (PFC) circuit comprising:
a PFC processor; and
a power stage circuit, comprising a first inductor and a power switching transistor; wherein
the PFC processor is configured to: output a first enable signal based on a comparison result between an inductor current of the first inductor and a preset current upper limit value; in response to the first enable signal being valid, allow the power switching transistor to be turned on; and in response to the first enable signal being invalid, not allow the power switching transistor to be turned on.

2. The power factor correction circuit according to claim 1, wherein a state of the first enable signal is configured for representing whether the inductor current is lower than a saturation current of the first inductor;
in response to the inductor current being lower than the saturation current, the first enable signal is valid; and
in response to the inductor current being equal to the saturation current, the first enable signal is invalid.

3. The power factor correction circuit according to claim 1, wherein the PFC processor comprises:
an enable circuit, configured to receive a current sampling signal representing the inductor current, and compare the current sampling signal with a first threshold to generate the first enable signal.

4. The power factor correction circuit according to claim 3, wherein the enable circuit generates the valid first enable signal in response to that the enable circuit receives the current sampling signal an absolute value of which is less than an absolute value of the first threshold.

5. The power factor correction circuit according to claim 3, wherein the enable circuit generates the invalid first enable signal in response to that the enable circuit receives the current sampling signal an absolute value of which is equal to an absolute value of the first threshold.

6. The power factor correction circuit according to claim 1, further comprising:
a current sampling circuit, wherein a first sampling terminal of the current sampling circuit is connected to a negative input terminal of the power stage circuit and an input terminal of the PFC processor, and a second sampling terminal of the current sampling circuit is connected to one terminal of the power switching transistor and an output terminal of the PFC processor and is grounded.

7. The power factor correction circuit according to claim 6, wherein in response to a current sampling signal being greater than a first threshold, the PFC processor generates the valid first enable signal; wherein the current sampling signal is a voltage at the first sampling terminal of the current sampling circuit, and the first threshold is less than zero.

8. The power factor correction circuit according to claim 1, further comprising:
a control signal generating circuit, comprising a set signal generating circuit, and configured to: in response to the first enable signal being valid, allow a set signal output by the set signal generating circuit to control the power switching transistor to be turned on; and in response to the first enable signal being invalid, not allow the set signal to control the power switching transistor to be turned on.

9. The power factor correction circuit according to claim 8, wherein the set signal generating circuit generates the set signal based on at least one of a first indicator signal representing an end of a sleep state, a second indicator signal representing a completion of a startup configuration, a third indicator signal representing a maximum off time, or a turn-on signal adapted to a working mode of the power stage circuit.

10. The power factor correction circuit according to claim 9, wherein the control signal generating circuit further comprises a reset signal generating circuit, wherein the reset signal generating circuit generates a reset signal based on at least one of a fourth indicator signal representing that the power factor correction circuit enters a protection state, a fifth indicator signal representing that the sleep state is entered, a sixth indicator signal representing a maximum on time, or a turn-off signal adapted to the working mode of the power stage circuit.

11. A display apparatus comprising:
a display panel;
a power supply circuit, comprising: a power factor correction (PFC) circuit; wherein
the power factor correction circuit comprises:
a PFC processor; and
a power stage circuit, comprising a first inductor and a power switching transistor;
wherein
the PFC processor is configured to: output a first enable signal based on a comparison result between an inductor current of the first inductor and a preset current upper limit value; in response to the first enable signal being valid, allow the power switching transistor to be turned on; and in response to the first enable signal being invalid, not allow the power switching transistor to be turned on; and
a backlight assembly, comprising a light source, electrically connected to the power supply circuit, and configured to, based on a power supply signal output from the power supply circuit, drive the light source to emit light to provide backlight to the display panel.

12. The display apparatus according to claim 11, wherein a state of the first enable signal is configured for representing whether the inductor current is lower than a saturation current of the first inductor;
in response to the inductor current being lower than the saturation current, the first enable signal is valid; and
in response to the inductor current being equal to the saturation current, the first enable signal is invalid.

13. The display apparatus according to claim 11, wherein the PFC processor comprises:
an enable circuit, configured to receive a current sampling signal representing the inductor current, and compare the current sampling signal with a first threshold to generate the first enable signal.

14. The display apparatus according to claim 13, wherein the enable circuit generates the valid first enable signal in response to that the enable circuit receives the current sampling signal an absolute value of which is less than an absolute value of the first threshold.

15. The display apparatus according to claim 13, wherein the enable circuit generates the invalid first enable signal in response to that the enable circuit receives the current sampling signal an absolute value of which is equal to an absolute value of the first threshold.

16. The display apparatus according to claim 11, wherein the power factor correction circuit further comprises:
a current sampling circuit, wherein a first sampling terminal of the current sampling circuit is connected to a negative input terminal of the power stage circuit and an input terminal of the PFC processor, and a second sampling terminal of the current sampling circuit is connected to one terminal of the power switching transistor and an output terminal of the PFC processor and is grounded.

17. The display apparatus according to claim 16, wherein in response to a current sampling signal being greater than a first threshold, the PFC processor generates the valid first enable signal; wherein the current sampling signal is a voltage at the first sampling terminal of the current sampling circuit, and the first threshold is less than zero.

18. The display apparatus according to claim 11, wherein the power factor correction circuit further comprises:
a control signal generating circuit, comprising a set signal generating circuit, and configured to: in response to the first enable signal being valid, allow a set signal output by the set signal generating circuit to control the power switching transistor to be turned on; and in response to the first enable signal being invalid, not allow the set signal to control the power switching transistor to be turned on.

19. The display apparatus according to claim 18, wherein the set signal generating circuit generates the set signal based on at least one of a first indicator signal representing an end of a sleep state, a second indicator signal representing a completion of a startup configuration, a third indicator signal representing a maximum off time, or a turn-on signal adapted to a working mode of the power stage circuit.

20. The display apparatus according to claim 19, wherein the control signal generating circuit further comprises a reset signal generating circuit, wherein the reset signal generating circuit generates a reset signal based on at least one of a fourth indicator signal representing that the power factor correction circuit enters a protection state, a fifth indicator signal representing that the sleep state is entered, a sixth indicator signal representing a maximum on time, or a turn-off signal adapted to the working mode of the power stage circuit.
